(19) United States
(12) Patent Application Publication
(10) Pub. No.: US 2008/0122940 A1
(43) Pub. Date: May 29, 2008

(54) IMAGE SHOOTING APPARATUS AND FOCUS CONTROL METHOD

(75) Inventor: Yukio MORI, Hirakata City (JP)

Correspondence Address: MOTS LAW, PLLC, 1001 PENNSYLVANIA AVE. N.W., SOUTH, SUITE 600, WASHINGTON, DC, 20004, US

(73) Assignee: SANYO ELECTRIC CO., LTD., Moriguchi City (JP)

(21) Appl. No.: 11/942,803

(22) Filed: Nov. 20, 2007

(30) Foreign Application Priority Data
Nov. 27, 2006 (JP) JP2006-317993

(51) Int. Cl. H04N 5/228

(52) U.S. Cl. 348/222.1; 348/E05.031

(57) ABSTRACT

An image shooting apparatus that calculates an AF evaluation value on the basis of an image signal of an AF evaluation area (focus evaluation area) provided in the frame image, and which performs an AF control by driving and controlling a focus lens so that the AF evaluation value can take a local maximum value. When an intentional camera operation (pan/tilt operation) is applied to the image shooting apparatus, the AF evaluation area is moved in the direction of movement of the image shooting apparatus, or the size of the AF evaluation area is reduced in the direction towards the center of the frame image.

### CROSS REFERENCE TO RELATED APPLICATIONS

This application claims priority based on 35 USC 119 from prior Japanese Patent Application No. P2006-317993 filed on Nov. 27, 2006, the entire contents of which are incorporated herein by reference.

### BACKGROUND OF THE INVENTION

1. Field of the Invention

The present invention relates to an image shooting apparatus and a focus control method used with the image shooting apparatus.

2. Description of Related Art

In general, autofocus control (hereinafter, referred to as AF control) using a through-the-lens (TTL) contrast detection method is used in an image shooting apparatus such as a digital still camera or digital video camera.

In this AF control, an AF evaluation area (focus evaluation area) is first set in a frame image (shot image), then, high frequency components of an image signal in the AF evaluation area are extracted, and an integration value of the extracted high frequency components is calculated as the AF evaluation value (focus evaluation value). This AF evaluation value is substantially proportional to the amount of contrast in the AF evaluation area since the amount of the high frequency components of the image signal increases as the amount of contrast in the AF evaluation area increases. Then, by use of a so-called hill-climbing control, the focus lens is driven and controlled so that the AF evaluation value can be kept around the maximum value.

In each frame image, the AF evaluation area is defined as a part of or the whole area of the frame image. Here, consider a case where the AF evaluation area is set as a partial rectangular area around the center of the frame image. Then, suppose that a landscape as shown in FIG. 19 is shot while an image shooting apparatus is moved in an upper right diagonal direction. Specifically, consider the case where the image shooting state is changed, by performing a pan or tilt operation (or a combination of these operations) of the image shooting apparatus, from a state of mainly shooting an image of flowers at near distance to a state of mainly shooting an image of the mountain at long distance.

In FIG. 19, rectangular areas 301, 302, 303, 304 and 305 represent image shooting areas at timings t1, t2, t3, t4 and t5, respectively. An assumption is made that time progresses in the order of timings t1, t2, t3, t4 and t5.

The image shooting apparatus shoots images sequentially in a predetermined frame cycle. Images 311, 312, 313, 314 and 315 in rectangular frames, each indicated by a solid line in FIG. 20, represent frame images obtained at timings t1, t2, t3, t4 and t5, respectively. AF evaluation area 350, which is also called a contrast detection area, is set around the center of each of frame images 311 to 315. Graphs each showing a relationship of the focus lens position and AF evaluation value for images 311, 312, 313, 314 and 315 are shown on the right side of FIG. 20.

Curved lines 321, 322, 323, 324 and 325 represent the respective relationships of the focus lens position and AF evaluation value corresponding to frame images 311, 312, 313, 314 and 315. In the graphs showing respective curved lines 321 to 325, a horizontal axis represents a focus lens position and the right side of the horizontal axis corresponds to a focus lens position that focuses on the long distance view side. However, since the image shooting apparatus successively drives and controls the focus lens position so that AF evaluation values can be kept around the maximum value (or local maximum value), the image shooting apparatus itself cannot recognize the relationships represented by curved lines 321 to 325.

At timing t1 corresponding to frame image 311, since the main object that fits in an image shooting area is the flowers at the near distance, the AF evaluation value takes a local maximum value when the focus lens position is located at a relatively near distance side, and this local maximum value matches the maximum value of the function represented by curved line 321. For this reason, the shooting of an image is performed in a state where the focus lens position is arranged at the relatively near distance side. As a result, an image in-focus on the flowers at the near distance can be obtained. In this case, however, the mountain is included in the AF evaluation area in frame 311 as an object, even though the mountain occupies only a small proportion of the AF evaluation areas. Accordingly, the AF evaluation value takes another local maximum value at the long distance side of the focus lens position.

As the timing shifts from timings t1 to t5, the magnitude relationship between the area sizes in the frame image occupied by the objects at the near distance and at the long distance is reversed. Then, in frame images 314 and 315, the local maximum values of the long distance view side are greater than the local maximum values of the near distance view side. Accordingly, when frame images 314 and 315 are shot, the focus lens position is to be driven and controlled so that the object at the long distance should be in-focus.

When shooting frame images 314 and 315, however, the AF evaluation value takes a local maximum value on the near distance side because the flower at the near distance remains in the AF evaluation area. For this reason, the hill-climbing control is inevitably influenced by this local maximum value on the near distance side. As a result, the object at the long distance which occupies a large portion of the frame image cannot be in-focus.

In a case of a conventional AF control, since the above described phenomenon occurs, a photographer needs to change the amount of the shooting area large enough to cause the object at the near distance to go outside of the frame once. In other words, the photographer needs to first perform a camera operation to move a camera more than necessary, and thereafter, the photographer needs to perform another camera operation to move a camera in the direction opposite to the direction of the first camera operation in order to obtain a desired composition. It is necessary to perform camera operations of panning the camera to the right and of panning again the camera to the left, for example. A technique to resolve such problem has not been proposed yet, and a proposal of the solution is desired.

It should be noted that Japanese Patent Application Laid-open Publication No. Hei 11-133475 discloses a technique of focusing on an object by use of any one of nine focus areas, and of changing the focus area from one to another when panning is detected. However, this technique only aims to make it easy to take a panning shot, and is not for solving the aforementioned specific problem that occurs when the hill-climbing control is performed.

In addition, Japanese Laid-open Patent Application Publications Nos. Hei 5-344403 and 6-22195 disclose a technique in which the motion of an object is detected, and a focus frame is moved so as to follow the object. This technique also does not contribute to a solution of the aforementioned specific problem.

### SUMMARY OF THE INVENTION

An aspect of the invention provides an image shooting apparatus that comprises an imaging unit configured to photoelectrically obtain a shot image, a motion detector configured to detect movement of an object in the shot image and to generate a motion vector, an area setting unit configured to receive the motion vector, and to set a focus evaluation area in the shot image, wherein the area setting unit changes a focus evaluation area position based on the motion vector, an evaluation unit configured to receive the shot image and to calculate a focus evaluation value corresponding to the amount of contrast in the focus evaluation area set by the area setting unit, and a controller configured to receive the focus evaluation value and to control the imaging unit so that the focus evaluation value can take an extreme value.

Furthermore, another aspect of the invention provides an image shooting apparatus that comprises an imaging unit configured to photoelectrically obtain a shot image, a motion detector configured to detect movement of an object in the shot image and then to generate a motion vector, an area setting unit configured to receive the motion vector, and to set a focus evaluation area in the shot image, wherein the area setting unit reduces the size of a focus evaluation area based on the motion vector, an evaluation unit configured to receive the shot image and to calculate a focus evaluation value corresponding to the amount of contrast in the focus evaluation area set by the area setting unit, and a controller configured to receive the focus evaluation value and to control the imaging unit so that the focus evaluation value can take an extreme value.

Still furthermore, another aspect of the present invention provides a focus control method that comprises detecting movement of an object in a shot image photoelectrically obtained by an imaging unit and then generating a motion vector, setting a focus evaluation area in the shot image by changing a focus evaluation area position in the shot image based on the motion vector, calculating a focus evaluation value corresponding to the amount of contrast in the focus evaluation area, and controlling the imaging unit so that the focus evaluation value can take an extreme value.

According to an aspects of the invention, an object focused in the past (an object at a near distance, for example) moves to the outside of the focus evaluation area at an early period. As a result, the process of making the main object (an object at a long distance, for example) in-focus after performing a camera operation is enhanced.

Furthermore, it is possible to provide an image shooting apparatus and an auto focus control method that provides an enhancement for, when a camera operation is applied, setting the main object to be in focus after the camera operation is applied.

### BRIEF DESCRIPTION OF THE DRAWINGS

FIG. 1 is an overall block diagram of an image shooting apparatus according to an embodiment.

FIG. 2 is a diagram showing an internal configuration of an imaging unit in FIG. 1.

FIG. 3 is a partial block diagram of the image shooting apparatus in FIG. 1, corresponding to a part related to AF control.

FIG. 4 is a diagram representing divided areas of each frame image, defined by a motion detector in FIG. 3.

FIG. 5 is a diagram showing an aspect in which each frame image shown in FIG. 4 is divided into a plurality of small areas.

FIG. 6 is a diagram representing a representative point and a plurality of sampling points, each of which is defined in one small area in FIG. 5.

FIG. 7 is an internal block diagram of the AF evaluation unit in FIG. 3.

FIG. 8 is a diagram describing a determination technique (pan/tilt determination technique) by a pan/tilt determination unit in FIG. 3.

FIG. 9 is a diagram describing the determination technique by the pan and title determination unit in FIG. 3, and is a diagram representing a relationship of a frame image, an area motion vector, a whole motion vector and a shock vector.

FIG. 10 is a diagram representing a landscape image shot by the image shooting apparatus in FIG. 1, and is a diagram showing an aspect in which the shooting areas change as the image shooting apparatus is shaken in the upper right oblique direction.

FIG. 11 is a diagram describing a technique to set an AF evaluation area by the AF evaluation area setting unit in FIG. 3, and is a diagram representing relationships of the each frame image and AF evaluation areas as well as the lens positions and AF evaluation values where a first area setting technique is applied.

FIG. 12 is a diagram showing a relationship of an XY coordinate system defined by the AF evaluation area setting unit in FIG. 3, and a shake vector and frame image.

FIG. 13 is a diagram showing an aspect in which the angle (θ) of a shake vector shown in FIG. 12 is classified into eight levels.

FIGS. 14A to 14I are diagrams each showing a position of the AF evaluation area in a frame image, the position being set in accordance with the direction of the shake vector.

FIGS. 15A to 15D are diagrams that show an aspect in which the AF evaluation area is gradually moved from a reference position to a target position through a plurality of stages.

FIG. 16 is a diagram showing a modification example of the position of the AF evaluation area shown in FIG. 14F.

FIG. 17 is a diagram for describing a technique to set an AF evaluation area by the AF evaluation setting unit in FIG. 3 and is a diagram showing relationships of the each frame image and AF evaluation areas as well as the lens position and AF evaluation values in a case where a second area setting technique is applied.

FIG. 18 is a flowchart showing the flow of an operation of the image shooting apparatus in FIG. 1, the operation relating to the setting of an AF evaluation area.

FIG. 19 is a diagram showing a landscape image shot by a conventional image shooting apparatus, and is a diagram showing an aspect in which the shooting areas change as the image shooting apparatus is shaken in the upper right oblique direction.

FIG. 20 is a diagram showing relationships of the each frame image and the AF evaluation areas as well as the lens positions and AF evaluation values.

### DETAILED DESCRIPTION OF EMBODIMENTS

Embodiments of the invention are specifically described below with reference to the drawings. Regarding the respective figures to be referenced, the same component among figures is given the same reference numeral, and redundant explanation thereof is omitted in principle. At first, common matters among the embodiments and references in each of the embodiments will be described, followed by description of the first to fourth embodiments.

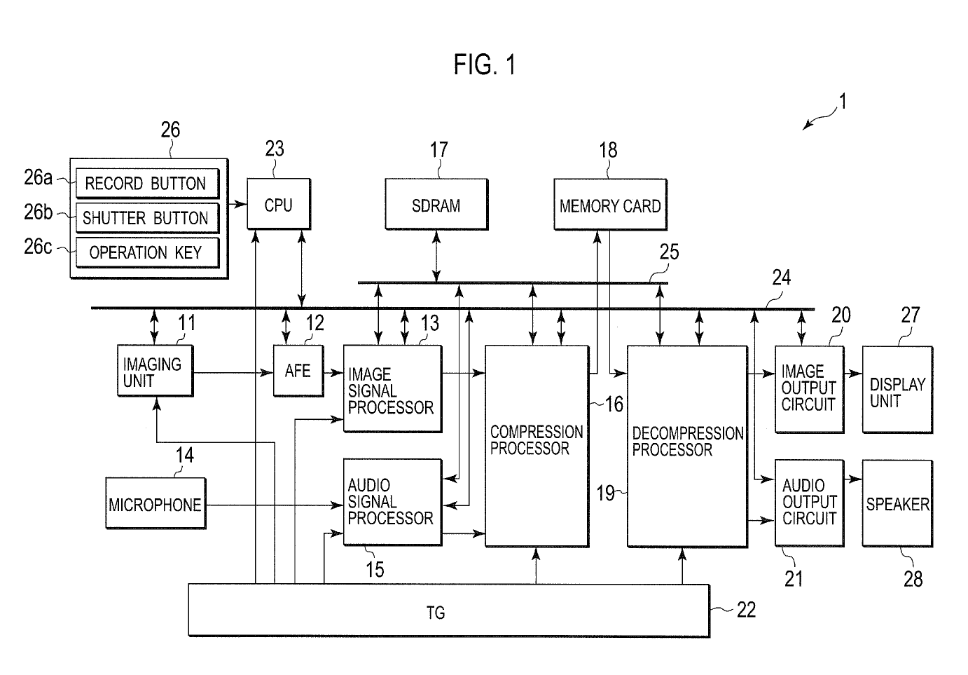

FIG. 1 is an overall block diagram of image shooting apparatus 1 according to an embodiment. Image shooting apparatus 1 is, for example, a digital video camera capable of shooting still pictures and motion pictures. Image shooting apparatus 1 may also be a digital still camera capable of shooting only still pictures, however.

Image shooting apparatus 1 includes imaging unit 11, analog front end (AFE) 12, image signal processor 13, microphone 14, audio signal processor 15, compression processor 16, synchronous dynamic random access memory (SDRAM) 17 as an example of an internal memory, memory card 18, decompression processor 19, image output circuit 20, audio output circuit 21, timing generator (TG) 22, central processing unit (CPU) 23, bus 24, bus 25, operation unit 26, display unit 27 and speaker 28. Operation unit 26 includes record button 26a, shutter button 26b, operation key 26c and the like. The respective components in image shooting apparatus 1 exchange signals (data) with one another via bus 24 or 25.

First, a description will be given of basic functions of image shooting apparatus 1 and the respective components constituting image shooting apparatus 1. TG 22 generates a timing control signal for controlling timings of respective operations in image shooting apparatus 1 on the whole and provides the generated timing control signal to the respective components in image shooting apparatus 1. Specifically, the timing control signal is provided to imaging unit 11, image signal processor 13, audio signal processor 15, compression processor 16, decompression processor 19 and CPU 23. The timing control signal includes a vertical synchronizing signal Vsync and a horizontal synchronizing signal Hsync.

CPU 23 controls the operations of the respective components in image shooting apparatus 1 as a whole. Operation unit 26 accepts operations by a user. Contents of operations provided to operation unit 26 are transmitted to CPU 23. SDRAM 17 functions as a frame memory. The respective components in image shooting apparatus 1 store various data (digital signals) temporarily in SDRAM 17 as appropriate at the time of processing a signal.

Memory card 18 is an external storage medium including a secure digital (SD) memory card, for example. It should be noted that although memory card 18 is shown as an example of the external storage medium in this embodiment, it is also possible to form the external storage medium by use of one or more randomly accessible storage media (including semiconductor memories, memory cards, optical disks, magnetic disks, and so forth).

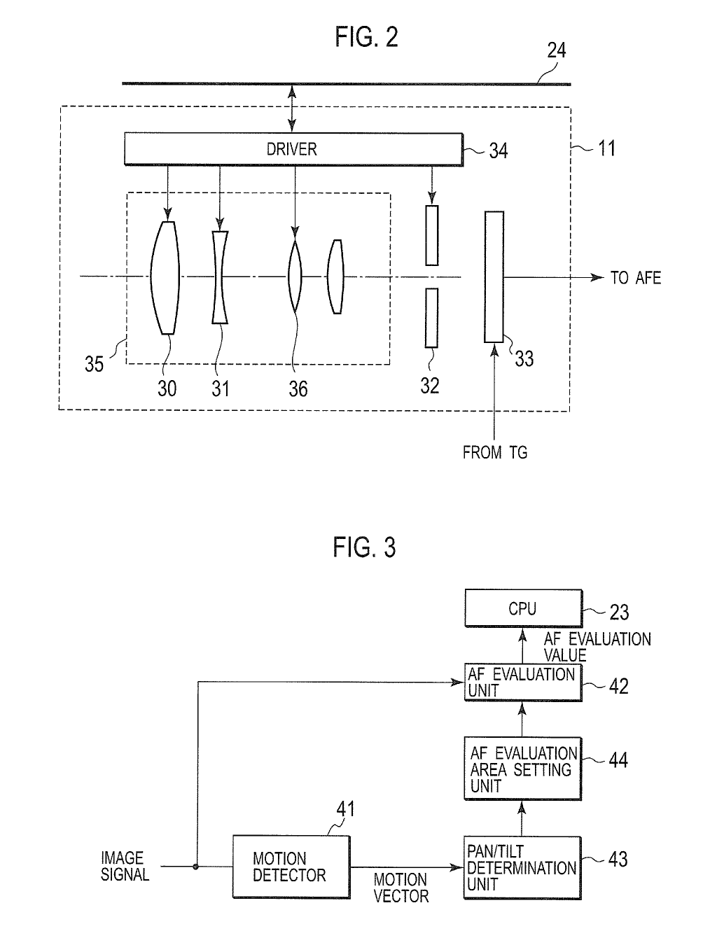

FIG. 2 is an internal configuration diagram of imaging unit 11 in FIG. 1. Imaging unit 11 photoelectrically obtains image data. Imaging unit 11 includes an imaging pickup element and an optical system for focusing an optical image in accordance with the object on the image pickup element. Imaging unit 11 obtains a picture image by shooting an image. Image shooting apparatus 1 is configured to be capable of generating a color image by applying color filters or the like to imaging unit 11 at the time of shooting an image.

Imaging unit 11 of the present embodiment includes optical system 35, diaphragm 32, image pickup element 33 and driver 34. Optical system 35 is configured of a plurality of lenses having zoom lens 30, focus lens 31 and correction lens 36. Zoom lens 30 and focus lens 31 are movable in an optical axis direction, and correction lens 36 is arranged in optical system 35 so as to be movable in a two-dimensional plane orthogonal to the optical axis.

Driver 34 controls the movement of zoom lens 30 and focus lens 31 on the basis of a control signal from CPU 23 and controls the zoom magnification ratio of or focus distance of optical system 35. Moreover, driver 34 controls the amount of aperture of diaphragm 32 (the size of aperture) on the basis of the control signal from CPU 23. Furthermore, driver 34 controls the position of correction lens 36 on the basis of a hand-shake control signal from CPU 23 to cancel shaking of an optical image on image pick-up element 32, stemming from the shaking of a hand holding image shooting apparatus 1. The hand-shake correction control signal is generated from a motion vector representing the motion of image shooting apparatus 1. Techniques to generate a motion vector will be described later.

Incident light from the object enters image pickup element 33 via each of the lenses constituting optical system 35 and diaphragm 32. The lenses constituting optical system 35 focus the optical image of the object on image pickup element 33. TG 22 generates a driving pulse for driving image pickup element 33 and provides the driving pulse to the image pickup element 33, the driving pulse being in synchronization with the timing control signal.

Image pickup element 33 is configured of a charge coupled device (CCD), a complementary metal oxide semiconductor (CMOS) image sensor or the like. Image pickup element 33 photoelectrically converts an optical image entered in imaging pickup element 33 via optical system 35 and diaphragm 32 into electric signals and then outputs the electrical signals obtained by the photoelectrical conversion to AFE 12. To be more specific, image pickup element 33 includes a plurality of pixels (light receiving pixels; not shown) arranged in a two-dimensional array in a matrix, and, in every image shot, each of the pixels stores therein a signal charge having the amount of charge equivalent to an exposure time. Electrical signals each having the amount proportional to the amount of charge of the stored signal charge, from the respective pixels, are sequentially outputted to AFT 12 in the subsequent process in accordance with the driving pulse from TG 22.

AFE 12 amplifies analog signals outputted from imaging unit 11 (image pickup element 33) and converts the amplified analog signals into digital signals. AFE 12 sequentially outputs the digital signals to image signal processor 13.

On the basis of the output signals from AFE 12, image signal processor 13 generates an image signal representing an image shot by imaging unit 11 (hereinafter, referred to as a “shot image”). The image signal is configured of a brightness signal Y representing brightness of the shot image, and color difference signals U and V each representing a color of the shot image. The image signal generated by image signal processor 13 is transmitted to compression processor 16 and image output circuit 20.

Microphone 14 converts audio (sound) provided from outside into an analog electrical signal and outputs the signal. Audio signal processor 15 converts the electrical signal (analog audio signal) outputted from microphone 14 into a digital signal. The digital signal obtained by this conversion process is transmitted to compression processor 16 as the audio signal representing the audio inputted to microphone 14.

Compression processor 16 compresses the image signal from image signal processor 13 by a predetermined compression method. At the time of shooting a moving image or still image, the compressed image signal is transmitted to memory card 18. In addition, compression processor 16 compresses the audio signal from audio signal processor 15 by a predetermined compression method. At the time of shooting a moving image, the image signal from image signal processor 13 and the audio signal from audio signal processor 15 are associated with each other on the basis of the timeline of the video. The associated image and audio signals are transmitted to memory card 18 after the signals are compressed.

Record button 26a is a press-button switch for a user to instruct the beginning and ending of shooting a moving image (video image). Shutter button 26b is a press-button switch for a user to instruct the shooting of a still image (still picture).

Operation modes of image shooting apparatus 1 include a shooting mode capable of shooting a moving image and still image, and a replaying mode in which a moving image or still image stored in memory card 18 is reproduced and displayed on display unit 27. In accordance with an operation performed on operation key 26c, a transition between the modes is executed.

In the shooting mode, the shooting of images is sequentially performed in a predetermined frame cycle (for example, 1/60 seconds). In the shooting mode, when a user presses record button 26a, image signals of respective frames and audio signals corresponding to the respective image signals of the frames after the button is pressed are sequentially recorded, under the control of CPU 23, in memory card 18 via compression processor 16. When the user presses record button 26a again, the shooting of the moving image ends. Specifically, the recording of the image signals and audio signals in memory card 18 ends, and thus the shooting of a single moving image ends.

Moreover, in the shooting mode, when a user presses shutter button 26b, the shooting of a still image is performed. Specifically, under the control of CPU 23, an image signal of a signal frame after the button is pressed is recorded, as the imaging signal representing the still image, in memory card 18 via compression processor 16.

In the replaying mode, when a user performs a predetermined operation on operation key 26c, the compressed image signals representing a moving image or still image recorded in memory card 18 are transmitted to decompression processor 19. Decompression processor 19 decompresses the received image signals and then transmits the decompressed image signals to image output circuit 20. Furthermore, in the shooting mode, normally, obtaining of shot images and generating image signals are sequentially performed regardless of the pressing of record button 26a or shutter button 26b, and the image signals are transmitted to image output circuit 20 for performing a so-called preview.

Image output circuit 20 converts the provided digital image signals into image signals in a format (analog image signals, for example) that can be displayed on display unit 27 and then outputs the converted image signals. Display unit 27 is a display device such as a liquid crystal display device and is configured to display images corresponding to the image signals.

Moreover, when a moving image is played in the replaying mode, the compressed audio signals corresponding to the recorded moving images in memory card 18 are also transmitted to decompression processor 19. Decompression processor 19 decompresses the received audio signals and then transmits the decompressed audio signals to audio output circuit 21. Audio output circuit 21 converts the provided digital audio signals into audio signals in a format (analog audio signals, for example) that can be output by speaker 28 and outputs the audio signals to speaker 28. Speaker 28 outputs the audio signals from audio output circuit 21 as audio (sound) to an outside.

Image shooting apparatus 1 in FIG. 1 performs a characteristic autofocus control (AF control). FIG. 3 is a partial block diagram of image shooting apparatus 1 corresponding to a part related to the AF control. Motion detector 41, AF evaluation unit 42, pan/tilt determination unit 43 and AF evaluation area setting unit 44 in FIG. 3 are included in image signal processor 13 in FIG. 1, for example. CPU 23 in FIG. 3 is the same CPU as the one shown in FIG. 1. Image signals representing respective frame images are provided to motion detector 41 and AF evaluation unit 42.

A shot image obtained in each frame is called a frame image. In this application, the definitions of the shot image and the frame image are the same. In each frame cycle, the first, the second, . . . , the (n−1)th, and the (nth frame) are transmitted sequentially in this order. The frame images in the first, the second, . . . , the (n−1)th, and the (nth frame) are respectively termed the first, the second, . . . , the (n−1)th, and the (nth frame) images (where n is an integer not less than 2).

It should be noted that image signal processor 13 is further provided with an AE evaluation unit (not shown) configured to detect an AE evaluation value corresponding to the brightness of a shot image. In addition, CPU 23 controls via driver 34 the amount of received light (the brightness of an image) by adjusting the degree of aperture of diaphragm 32 (and the degree of amplification of signal amplification in AFE 12 as appropriate) in accordance with the AE evaluation value.

[Motion Detector]

First, functions of motion detector 41 in FIG. 3 will be described. Each shot image is perceived in a manner that the shot image is divided into M pieces in a vertical direction and N pieces in a horizontal direction. For this reason, each shot image is considered as an image divided into (M×N) divided areas. M and N are integers not less than 2 respectively. The values of M and N may be the same or different.

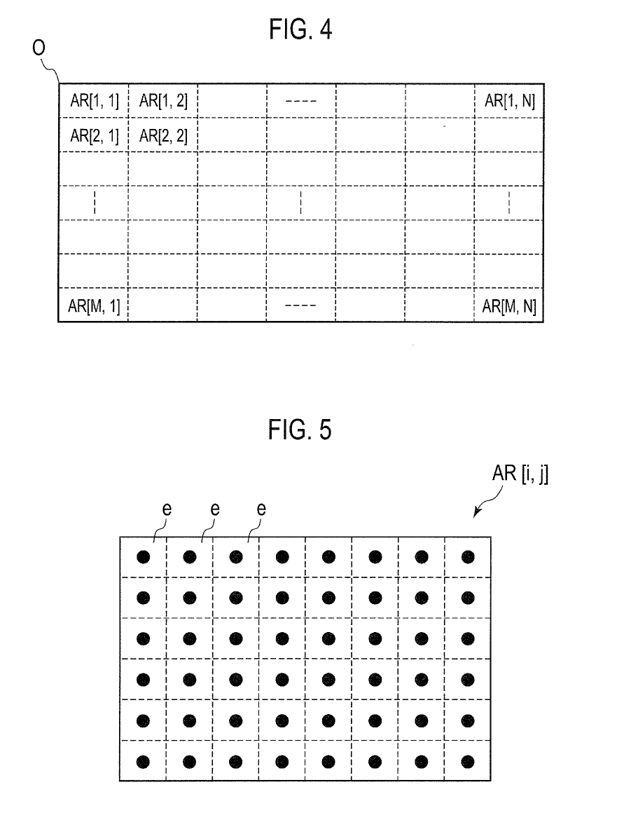

An aspect of dividing each shot frame is shown in FIG. 4. (M×N) pieces of the divided area are perceived as a matrix with M rows and N columns. Each divided area is expressed by AR[i,j] with origin O of the shot image as the basis. Here, i and j each takes an integer that satisfies the conditions of 1≦i≦M and 1≦j≦N. Divided areas AR[i,j] having the same i are constituted of pixels on the same horizontal line, and divided areas AR[i,j] having the same j are constituted of pixels on the same vertical line.

Motion detector 41 detects a motion vector between frame images adjacent to each other for each divided area AR [i,j] by comparing an image signal in a frame with an image signal in a frame adjacent to each other by use of a known image matching method (a block matching method or representative point matching method, for example). A motion vector detected for each divided area AR [i,j] is specifically called an area motion vector. An area motion vector for a certain divided area AR [i,j] specifies the size and direction of the image in the particular divided area AR[i,j] between the frame images adjacent to each other.

As an example, focusing on a certain divided area AR[i,j], a description will be given of a method for calculating, by use of a representative point matching method, an area motion vector for the certain divided area AR [i,j] between the n−1th frame image and the nth frame image adjacent to each other.

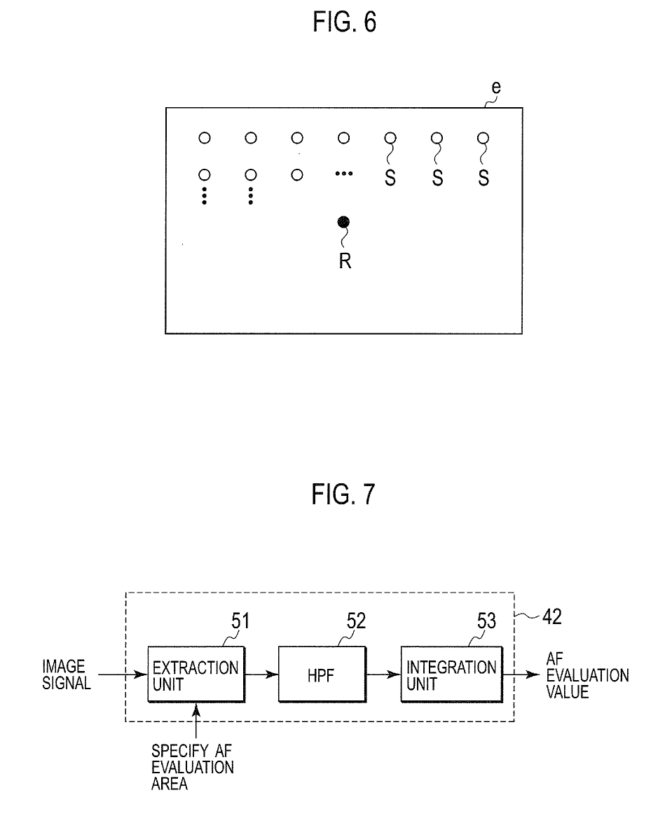

As shown in FIG. 5, one divided area AR [i,j] is divided into a plurality of small areas e (detection blocks). In the example shown in FIG. 5, the one divided area AR [i,j] is divided into 48 small areas e (divided into six pieces in a vertical direction and 8 pieces in a horizontal direction). Each of the small areas e is configured of 32×32 pixels (32 pixels in the vertical direction and 32 pixels in the horizontal direction arranged in a two dimensional array). Then, as shown in FIG. 6, a plurality of sampling points S and one representative point R are set in each of the small areas e. As to a certain small area e, the plurality of sampling points S correspond to all the pixels constituting the small area e, for example (provided that except for the representative point R).

Absolute values are found with respect to all the small areas e. Each of the absolute values is the difference between the brightness value of each of the sampling points S in each of the small areas e in the nth frame image and the brightness value of the representative point R in each of the small areas e corresponding to the (n−1) frame image. The absolute value found for a certain sampling point S is called a correlation value in the sampling point S. Moreover, the brightness value is the value of the brightness signal that forms an image signal.

Then, correlation values of the sampling points S having the same deviation with respect to the representative point R between all the small areas e in a divided area are accumulated and added (48 correlation values are accumulated and added in the case of this example). In other words, absolute values of the differences of the brightness values found for the pixels at the same positions (the same positions in the coordinate in the small area) in each of the small areas e accumulated and added for 48 pieces of the small areas e. The value obtained by this accumulation and addition is called an “accumulated correlation value.” The accumulated correlation value is also called a matching error in general. The same number of accumulated correlation values as the number of sampling points S in one small area e is to be found.

Then, the deviation of the representative point R and the sampling point S whose accumulated correlation value becomes the minimum, that is, the deviation having the highest correlation is detected. In general, the deviation is extracted as the area motion vector of the divided area.

Moreover, motion detector 41 determines validity or invalidity of each of the divided areas AR [i,j] in consideration of the reliability of the area motion vector calculated from each of the divided areas [i,j]. Various techniques have been proposed as the determination technique, and motion vector detector 41 is capable of employing any one of the techniques. For example, a technique disclosed in Japanese Patent Application Laid-open Publication No. 2006-101485 may be used.

Focusing on one divided area AR [i,j], a technique to determine validity or invalidity of the divided area AR [i,j] will be exemplified. In a case where an area motion vector as to the focused divided area is calculated by use of a representative point matching method as described above, a plurality of accumulated correlation values are calculated as to the focused divided area. Motion detector 41 determines whether or not a first condition that “the average value of the plurality of the accumulated correlation values is greater than a predetermined value TH1” is satisfied. Moreover, motion detector 41 determines whether or not a second condition that “the value obtained by dividing the average value of the plurality of accumulated correlation values by the minimum correlation value is greater than a predetermined value TH2” is satisfied. The minimum correlation value is the minimum value among the aforementioned plurality of the accumulated correlation values. Then, in a case where both of the first and second conditions are satisfied, the divided area is determined to be valid, and otherwise, the divided area is determined to be invalid. The aforementioned process is performed for each of the divided areas. It should be noted that the second condition is changed to a condition that “the minimum correlation value is smaller than a predetermined value TH3.”

Then, motion detector 41 finds the average vector of the calculated area motion vectors as to the valid divided areas AR [i,j], and outputs the average vector as a whole motion vector (shake vector). In a case where there is no motion in the object itself that fits in the shot image, the whole motion vector represents the direction and amount of the motion of image shooting apparatus 1 between adjacent frames. Hereinafter, the area motion vector calculated as to the valid divided areas AR [i,j] is termed as a “valid area motion vector.”

[AF Evaluation Unit]

Next, functions of AF evaluation unit 42 in FIG. 3 will be described. FIG. 7 is an internal block diagram of AF evaluation unit 42. AF evaluation unit 42 is configured of and includes extraction unit 51, high pass filter (HPF) 52 and integration unit 53. AF evaluation unit 42 calculates one AF evaluation value (focus evaluation value) for one frame image.

Extraction unit 51 extracts a brightness signal in an AF evaluation area (focus evaluation area) defined in a frame image. AF evaluation area setting unit 44 in FIG. 3 specifies the position and size of the AF evaluation area in the frame image (details are to be described later). HPF 52 extracts only a predetermined high frequency component in the brightness signal extracted by extraction unit 51.

Integration unit 53 finds an AF evaluation value corresponding to the amount of contrast of an image in the AF evaluation area by integrating the absolute values of high frequency components extracted by HPF 52. AF evaluation values calculated for the respective frame images are sequentially transmitted to CPU 23. An AF evaluation value is almost proportional to the amount of contrast and increases as the amount of contrast increases.

CPU 23 temporarily stores the sequentially provided AF evaluation values, and controls the position of focus lens 31 via driver 34 by use of a so-called hill-climbing control so that the AF evaluation value can be kept around the maximum value (refer to FIGS. 2 and 3). As focus lens 31 moves, the contrast of the image changes, and the AF evaluation value changes as well. By use of the hill-climbing control, CPU 23 controls the position of focus lens 31 in a direction where the AF evaluation value becomes larger. As a result, the amount of contrast of the image in the AF evaluation area with respect to the same optical image can be kept near the maximum value.

[Pan/Tilt Determination Unit]

Pan/tilt determination unit 43 (hereinafter, referred to as “determination unit 43”) determines, with reference to the whole motion vectors and area motion vectors calculated by motion detector 41 for a plurality of frames, whether or not the motion of image shooting apparatus 1 between adjacent frame originated from an intentional movement (intentional camera operation).

The intentional movement includes a camera operation in which the photographer intentionally pans image shooting apparatus 1 to the left and right, a so-called pan operation, and a camera operation in which the photographer intentionally pans image shooting apparatus 1 up and down, a so-called tilt operation.

The determination technique of determination unit 43 will be described in detail. The determination is made by determining whether or not both a “first pan/tilt condition” and “second pan/tilt condition” are satisfied.

First, the first pan/tilt condition will be described. The determination of satisfaction of the first pan/tilt condition is made by comparing one whole motion vector with each of the valid area motion vectors calculated between two adjacent frames. From the result of this comparison, a determination is made whether following first element condition and second element condition are satisfied as to each of the valid area motion vectors. Then, the number V_{NUM} of valid motion vectors that satisfy at least one of the first and second element conditions is counted. Then, if the number V_{NUM} is not less than a predetermined value ((¾)×M×N, for example), a determination is made that the first pan/tilt condition is satisfied and otherwise, a determination is made that the first pan/tilt condition is not satisfied.

The first element condition is a condition wherein “the amount of a difference vector between an area motion vector and whole motion vector is not greater than 50% of the amount of the whole motion vector.” The second element condition is a condition wherein “the amount of a difference vector between an area motion vector and whole motion vector is not greater than a predetermined value.”

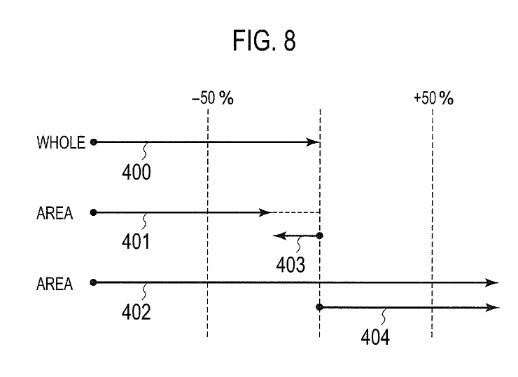

A specific example of a case where the first element condition is satisfied/unsatisfied will be described with reference to FIG. 8. In the instance where whole motion vector 400 is compared with area motion vector 401, the size of difference vector 403 of the two vectors is not greater than 50% of the size of whole motion vector 400. For this reason, area motion vector 401 satisfies the first element condition. In a case where whole motion vector 400 is compared with area motion vector 402, the size of difference vector 404 of the two vectors exceeds 50% of the size of whole motion vector 400. For this reason, area motion vector 402 does not satisfy the first element condition. Likewise, the same can be said as to the second element condition.

In the case where image shooting apparatus 1 is still (is fixed) and where a moving object does not exist in the shooting area, however, the size of each area motion vectors substantially becomes zero. Because of this fact, the size of the whole motion vector substantially becomes zero as well. Accordingly, where image shooting apparatus 1 becomes still and where a moving object does not exist in the shooting area, most of the area motion vectors satisfy the second element condition (and first element condition). For this reason, regardless of whether the first and second element conditions are satisfied, it is determined that the first pan/tilt condition is not satisfied in a case where the size of the whole motion vector is not greater than a predetermined value.

When the first pan/tilt condition is satisfied between two adjacent frame images, determination unit 43 calculates a shake vector from the whole motion vector between the two adjacent frame images and temporarily stores the shake vector for making a determination whether or not the second condition is satisfied. The shake vector (pan/tilt vector) is a vector whose direction is reverse to the whole motion vector. The sizes of both vectors are the same.

On the basis of the determination of whether or not the first pan/tilt condition is satisfied, it is difficult to distinguish an intentional movement by the photographer from unintentional shaking of a hand holding the device. Accordingly, determination unit 43 determines whether or not the second pan/tilt condition is satisfied.

The second pan/tilt condition will be described. In order for the second pan/tilt condition is to be satisfied, it is necessary that the first pan/tilt condition be satisfied in a predetermined number of frames in a row. Provided that the first pan/tilt condition is satisfied in a predetermined number of frames in a row, the average shake vector is calculated by taking the average of the motion vectors of the predetermined number of frames, and then, the average shake vector is compared with each of the shake vectors of the predetermined number of frames. In a case where all the shake vectors of the predetermined number of frames satisfy at least one of the following third and fourth element conditions, a determination is made that the second pan/tilt condition is satisfied, and otherwise, a determination is made that the second pan/tilt condition is not satisfied.

The third element condition is a condition that “the amount of a difference vector between the shake vector and the average shake vector is not greater than 50% of the amount of the average shake vector.” The fourth element condition is a condition that “the amount of a difference vector between the shake vector and the average shake vector is not greater than a predetermined value.”

Determinations whether or not the third and fourth element conditions are satisfied are made by use of the same determination technique described in detail with reference to FIG. 8 and used for making the determination whether or not the first element condition is satisfied.

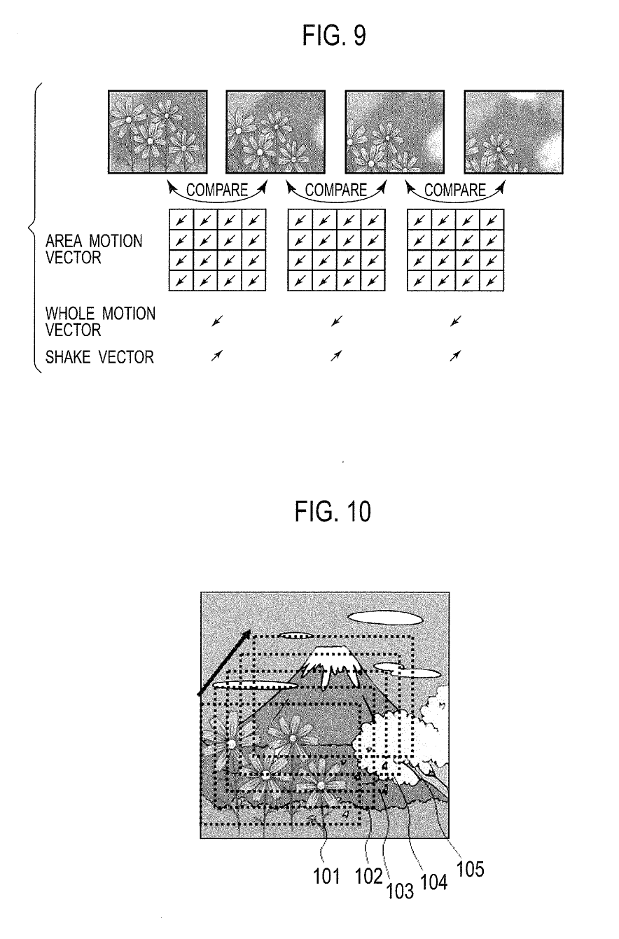

While image shooting apparatus 1 is continuously panned in an oblique direction for a certain period of time, for example, as shown in FIG. 9, the amount of each of the area motion vectors is approximately the same as those of others in the same direction during this period. Accordingly, the second pan/tilt condition is satisfied after several frames from the time when image shooting apparatus 1 starts moving in the oblique direction.

Determination unit 43 determines that an intentional movement is applied to image shooting apparatus 1 at the time when the second pan/tilt condition is satisfied. Then, while the second pan/tilt condition is satisfied, determination unit 43 outputs, to AF evaluation area setting unit 44 (refer to FIG. 3), a pan/tilt determination signal and sequentially calculated shake vectors. Thereafter, when the first and/or second pan/tilt condition becomes unsatisfied, determination unit 43 determines that an intentional movement is not applied to image shooting apparatus 1, and then stops outputting the pan/tilt determination signal and shake vectors.

[AF Evaluation Area Setting Unit]

AF evaluation area setting unit 44 in FIG. 3 (hereinafter, abbreviated as “area setting unit 44”) sets the position and size of aforementioned AF evaluation area in a frame image on the basis of the result of determination made by determination unit 43 and a shake vector provided by determination unit 43.

As the technique to set the position and size of an AF evaluation area, the first and second area setting techniques will be exemplified.

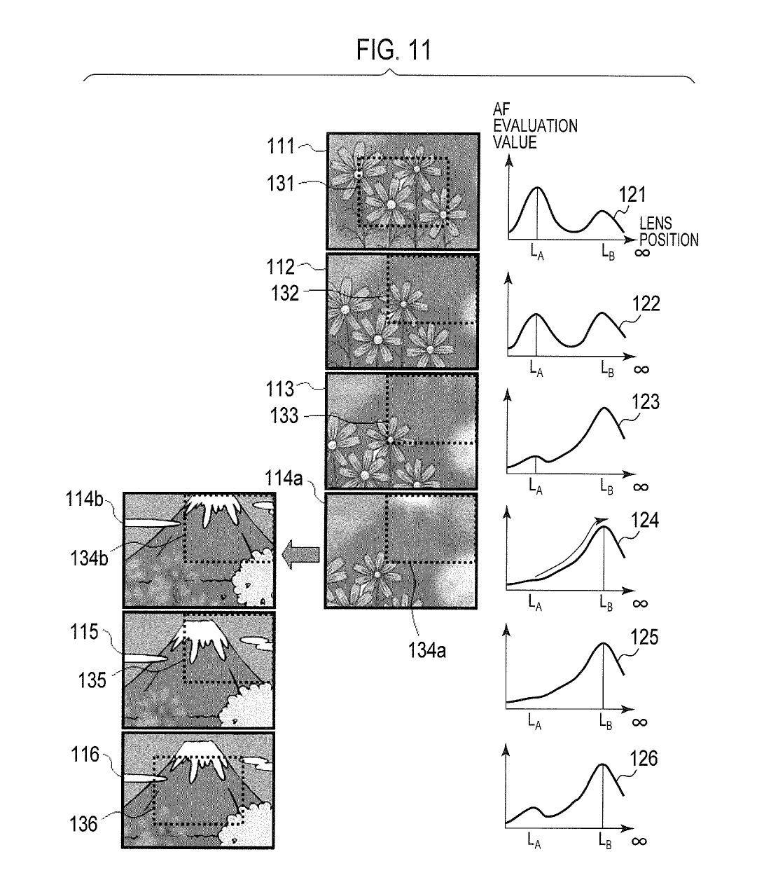

First, the first area setting technique will be described with reference to FIGS. 10 and 11 representing a specific example to which the first area setting technique is applied.

Consider a case where an image of a landscape as shown in FIG. 10 is shot by image shooting apparatus 1 while image shooting apparatus 1 is panned in the upper right oblique direction. Specifically, consider a case where the state of shooting the image shifts from the state of shooting flowers, as the main object, at a near distance to the state of shooting a mountain, as the main object, at long distance, through the pan or tilt operation (or a combination of the two operations). Such shift is made through timings T1 to T5.

In FIG. 10, rectangular areas 101, 102, 103, 104 and 105 represent shooting areas at T1, T2, T3, T4 and T5, respectively. An assumption is made that the time progresses in the order of T1, T2, T3, T4 and T5.

In FIG. 11, images 111, 112, 113, 114 and 115 each surrounded by a rectangular frame indicated by a solid line represent frame images obtained at timings T1, T2, T3, T4 and T5, respectively. Images 114b and 116 each surrounded by a rectangular frame indicated by a solid line represent frame images each obtained at a timing after timing T4 but before T5, and at timing T6 that comes after T5.

AF evaluation areas 131, 132, 133, 134a, 134b, 135 and 136 each can be also termed as a contrast detection area are set to frame images 111, 112, 113, 114a, 114b, 115 and 116, respectively, by area setting unit 44.

Graphs are shown on the right side of FIG. 11. Each of the graphs represents a relationship between the position of focus lens 31 (hereinafter, referred to as “lens position”) and an AF evaluation value. Curved lines 121, 122, 123, 124, 125 and 126 each representing a relationship between a lens position and AF evaluation value correspond to frame images 111, 112, 113, 114a (or 114b), 115 and 116, respectively.

In each of the graphs showing respective curved lines 121 to 126, a horizontal axis indicates that the lens position and the right side of the horizontal axis corresponds to the lens position focusing on the long distance side. Image shooting apparatus 1 successively drives and controls the lens position so that the AF evaluation value can be kept around the maximum value (or local maximum value). Specifically, image shooting apparatus 1 itself, does not have to recognize the relationships expressed by curved lines 121 to 126.

L_{A} is shown in the horizontal axis of each of the graphs and represents a lens position in-focus on the flowers at a near distance included in the shooting area. L_{B} is shown in the horizontal axis of each of the graphs and represents a lens position in-focus on the mountain at a long distance included in the shooting area. Specifically, the distance between image shooting apparatus 1 and the flowers is shorter than the distance between image shooting apparatus 1 and the mountain.

At timing T1 corresponding to frame image 111, image shooting apparatus 1 is fixed, and the flowers at a near distance are the main object. Since image shooting apparatus 1 is fixed, a pan/tilt signal is not outputted at timing T1. In this case, area setting unit 44 sets the AF evaluation area to be the reference area. The reference area is a partial rectangular area around the center of the frame image. An assumption is made that the center of the reference area matches with the center of the frame image. AF evaluation area 131 in FIG. 11 is the reference area.

At timing T1, the main object fitting in the image shooting area is the flowers at a near distance. Accordingly, in a state where the lens position is relatively at the near distance side, that is, a state where the lens position matches with L_{A}, the AF evaluation value takes a local maximum value and this local maximum value (hereinafter, referred to as “near distance side local maximum value”) matches with the maximum value of the function represented by curved line 121. For this reason, an image is shot in the state where the lens position is at L_{A}. As a result, an image in-focus on the flowers at the near distance can be obtained. However, although the proportion of an area that occupies the AF evaluation area is small, the mountain at a long distance is included as an object in the AF evaluation area in frame image 111. Accordingly, the AF evaluation value takes another local maximum value (hereinafter, referred to as “long distance side local maximum value”) in a state where the lens position is at the long distance view side, that is, a state where the lens position matches with L_{B}.

Image shooting apparatus 1 is panned in the upper right oblique direction from timings T1 to T2. Thereby, determination unit 43 determines by the aforementioned determination process that an intentional movement is applied to image shooting apparatus 1 and outputs a pan/tilt determination signal and shake vector to setting unit 44. Upon receipt of these, area setting unit 44 causes the AF evaluation area to move in a direction corresponding to the direction of the provided shake vector in the frame image. As it is clear from the aforementioned description, the direction of the shake vector matches (or substantially matches) with the direction of the movement of image shooting apparatus 1.

As a result of this, AF evaluation area 132 different from the reference area is set in frame image 112 in FIG. 11. In this example, since image shooting apparatus 1 is panned in the upper right oblique direction, AF evaluation area 132 is provided on the upper right side of frame image 112. AF evaluation area 132 is a rectangular area, and the center of the rectangular area is shifted from the center of frame image 112 in a direction towards the direction of the shake vector. The camera operation in which image shooting apparatus 1 is panned in the upper right oblique direction is continued until timing T5. As a result, AF evaluation areas 133, 134a, 134b and 135 are also provided at the same position as that of AF evaluation area 132 in the respective frame images. Due to such shifting of the AF evaluation areas, the object at the near distance is excluded from the AF evaluation areas at an early period.

As the time progresses from timings T1 to T5, the magnitude relationship between the area sizes in the frame image occupied by the objects at the near distance and at the long distance is reversed. Then, in frame image 113, the long distance side local maximum value becomes greater than the near distance side local maximum value. At timing T3 corresponding to frame image 113, the near distance side local maximum value still exists and the lens position is set to L_{A}. Thereafter, when the time progresses to timing T4, however, the near distance side local maximum value disappears, and the lens position is controlled to move towards L_{B} by the hill-climbing control. The moving of the AF evaluation area contributes to such disappearance (disappearance at an early period) of the near distance side local maximum value.

Frame image 114a is the frame image that can be obtained immediately after the near distance side local maximum value disappears. At the timing of shooting this frame image, the lens position still matches with L_{A}. Thereafter, as the lens position moves towards L_{B} from L_{A}, frame image 114b in-focus at the long distance can be obtained.

Thereafter, at timing T5, the lens position matches with L_{B}, and the near distance side local maximum value no longer exists. Assume that the camera operation made to image shooting apparatus 1 at the timing immediately after timing T5 ends, and the time progresses to timing T6. Specifically, assume that image shooting apparatus 1 is fixed at timing T6. In this case, since a pan/tilt signal is not outputted at timing T6, area setting unit 44 returns the AF evaluation area to be the reference area. Specifically, AF evaluation area 136 corresponding to timing T6 is the reference area. As a result of this, the two local maximum values (specifically, the near distance side local maximum value and long distance side local value) appear in the function expressed by curved line 126. However, since the hill-climbing control is executed around the long distance side local maximum value corresponding to L_{B}, the state of the lens position in-focus on an object at the long distance is maintained.

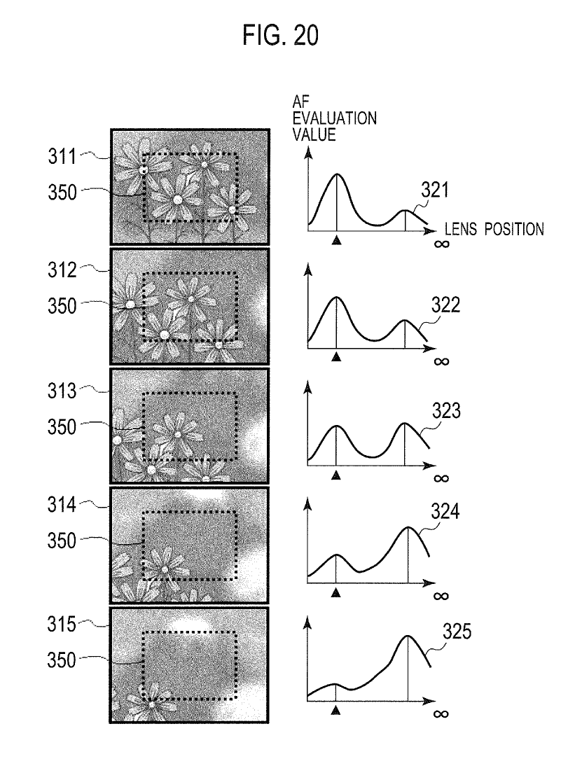

As described above, in the first area setting technique, the AF evaluation area is moved in the direction of the movement of image shooting apparatus 1 when an intentional movement is applied to image shooting apparatus 1. This is because the object to be shot by the photographer is supposed to exist in the direction of the movement of image shooting apparatus 1. Thereby, as it can be seen from a comparison between FIG. 11 and FIG. 20 that is related to a conventional technique, the lens position can be in-focus on the object of the long distance to be shot by the photographer faster, and a camera operation to frame out the near distance view is no longer necessary.

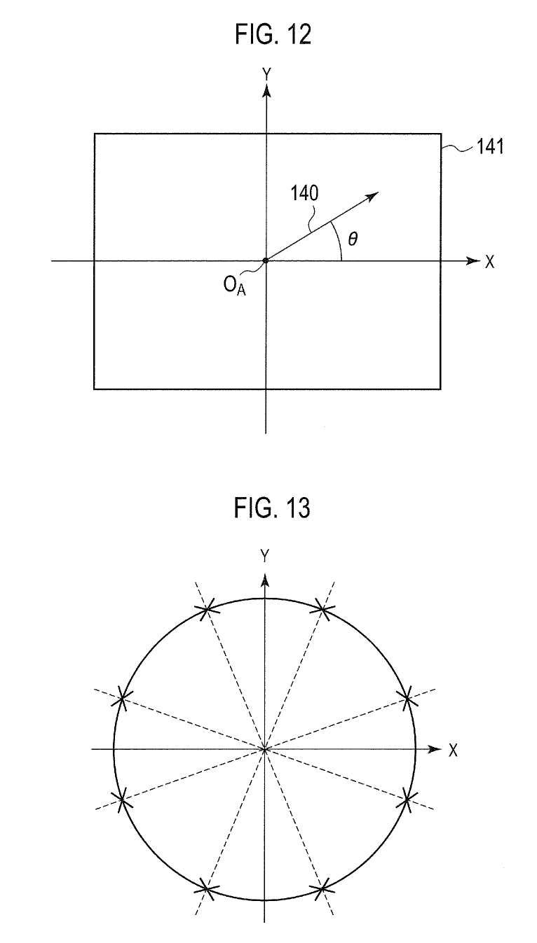

A setting example of an AF evaluation area when an intentional movement is applied to image shooting apparatus 1 will be described with reference to FIGS. 12 to 14A to 14I. An XY coordinate system taking X and Y axes each being as a coordinate axis is defined in a frame image. In FIG. 12, this XY coordinate system is shown. Then, the center O_{A} Of the frame image and the origin of the XY coordinate system are matched with each other, and the starting point of a shake vector is matched with the origin.

In FIG. 12, reference numeral 140 denotes the shake vector, and a rectangular frame denoted by a solid line with reference numeral 141 represents an outer shape of the entire area of the frame image. X axis is in parallel with the horizontal direction of the frame image, and Y axis is in parallel with the vertical direction of the frame image. An angle formed by X axis and shake vector 140 is denoted by θ (in unit of “radian”). Although two types of angles including one when viewing shake vector 140 from X axis in a clockwise direction, and one when viewing shake vector 140 from X axis in a counter clockwise direction can be defined as the angle, the latter is defined as angle θ. Accordingly, the end point of shake vector 140 is positioned at the first quadrant, 0<θ<π/2 is true.

Angle θ is classified into eight levels as shown in FIG. 13. Specifically, when 15π/8≦θ<2π or 0≦θ0<π/8 is true, angle θ is classified as the first angle level. When π/8≦θ<3π/8 is true, angle θ is classified as the second angle level. When 3π/8≦θ<5π/8 is true, angle θ is classified as the third angle level. When 5π/8≦θ<7π/8 is true, angle θ is classified as the fourth angle level. When 7π/8≦θ<9π/8 is true, angle θ is classified as the fifth angle level. When 9π/8≦θ<11π/8 is true, angle θ is classified as the sixth angle level. When 11π/8≦θ<13π/8 is true, angle θ is classified as the seventh angle level. When 13π/8≦θ<15π/8 is true, angle θ is classified as the eighth angle level.

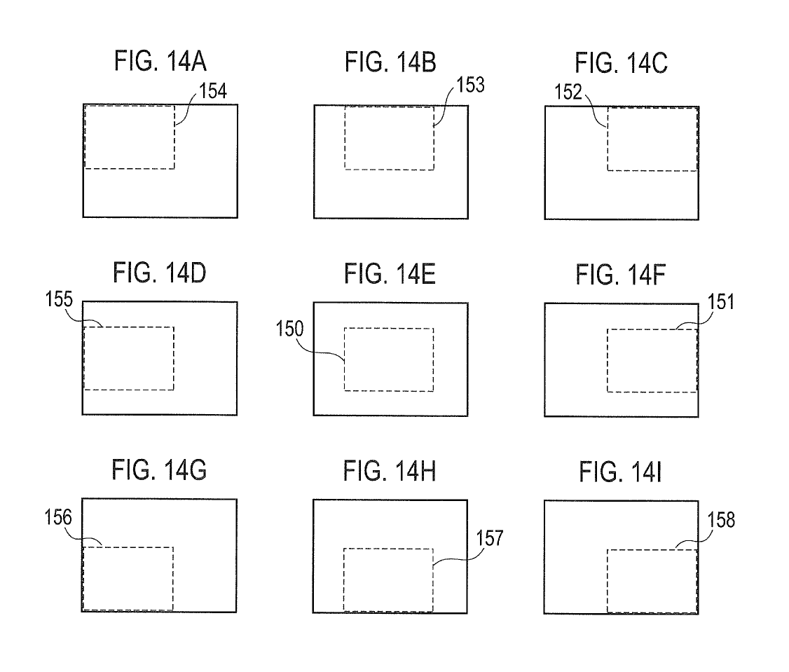

Then, the AF evaluation area is set to be the reference area as shown in FIG. 14E when a pan/tilt determination signal is not outputted. In FIG. 14E, reference numeral 150 denotes an AF evaluation area that matches with the reference area. As described above, the center of the reference area matches with the center O_{A} of the frame image. FIGS. 14A to 14I each represent the positions of the AF evaluation area provided in the frame image. In respective FIGS. 14A to 14I, a rectangular frame denoted by a solid line represents an outer shape of the entire area of the frame image, and a rectangular frame denoted by a broken line represents an outer shape of the AF evaluation area.

When a pan/tilt determination signal is outputted and also angles θ of the shake vectors are classified into the first to eight angle levels, the AF evaluation areas are respectively set to AF evaluation area 151 of FIG. 14F in which the reference area is shifted to a right direction; AF evaluation area 152 of FIG. 14C in which the reference area is shifted to an upper right direction; AF evaluation area 153 of FIG. 14B in which the reference area is shifted to an upper direction; AF evaluation area 154 of FIG. 14A in which the reference area is shifted to an upper left direction; AF evaluation area 155 of FIG. 14D in which the reference area is shifted to a left direction; AF evaluation area 156 of FIG. 14G in which the reference area is shifted to a lower left direction; AF evaluation area 157 of FIG. 14H in which the reference area is shifted to a lower direction; and AF evaluation area 158 of FIG. 14I in which the reference area is shifted to a lower right direction. Here, the upper, lower, left and right directions respectively correspond to the positive direction of X axis, the positive direction of Y axis, the negative direction of X axis and the negative direction of Y axis.

In the XY coordinate system, although the center of AF evaluation area 150 matches with the origin O_{A} of the frame image, each of the centers of AF evaluation areas 151 to 158 does not match with the origin O_{A}. To be more specific, angles (in unit of “radian”) each formed by a linear line connecting the each of the centers of AF evaluation areas 151 to 158 with the origin O_{A} and X axis are respectively set as 0, π/4, π/2, 3π/4, π, 5π/4, 3π/2 and 7π/4. These angles are, however, angles when viewing each of the linear lines from X axis in counter clockwise direction.

Moreover, when the state where a pan/tilt determination signal is not outputted shifts to the state where a pan/tilt determination signal is outputted, the AF evaluation area can be moved from the reference position (the position of the reference area) to a target position at once. It is, however, preferable that the AF evaluation area be gradually moved from the reference position towards the target position through a plurality of levels. Consider a case where a pan/tilt determination signal is not outputted with respect to the (n−1)th frame image and where a pan/tilt determination signal is outputted with respect to each of the frame images subsequent to the nth frame image. Then, consider a case where the direction of the shake vector is the right direction, that is, angle θ is classified as the first angle level.

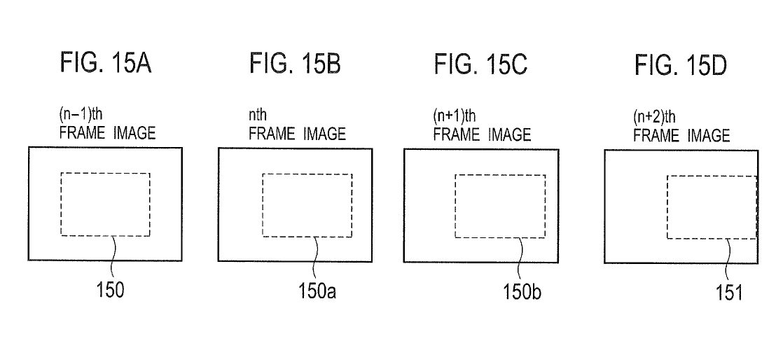

In this case, the position of the AF evaluation area is moved from the position of AF evaluation area 150 of FIG. 14E (that is, the reference position) until the position of AF evaluation area 151 of FIG. 14F (that is, the target position). In this case, as shown in FIGS. 15A to 15D, this movement is to be gradually executed by use of a plurality of frames. In FIGS. 15A to 15D, AF evaluation areas 150 and 151 are the same as those of FIGS. 14E and 14F. Then, the position (the center position) of each of the AF evaluation areas is shifted to a right direction in the order of AF evaluation areas 150, 150a, 150b and 151. It should be noted that although the position of each of AF evaluation areas is moved from the reference position to the target position though three levels of movement for the sake of simplification of description and illustration, the position may be moved to the target position through the number of levels other than this.

Hypothetically, in a case where the AF evaluation area is moved from the reference position to the target position at once, the object that fits in the AF evaluation area also changes at once, so that the continuity of the AF evaluation values are not assured, resulting in the occurrence of a situation where it is not clear whether focus lens 31 should be moved to either the long distance side or near distance side in the hill-climbing control (specifically, there is a concern that the hill-climbing control may be interrupted once). On the other hand, when the AF evaluation area is gradually moved from the reference position to the target position by use of a plurality of levels, as described above, the continuity of the AF evaluation values is assured, thus avoiding the occurrence of the interruption of the hill-climbing control.

Moreover, although there is described a case where the size (the amount) of the AF evaluation area is kept at constant while the position of the AF evaluation area is moved in a frame image, as an example in FIGS. 14A to 14I, the size of the AF evaluation area may be changed when a pan/tilt determination signal is outputted.

The size of the AF evaluation area when a pan/tilt determination signal is outputted may be, for example, smaller than the size thereof (specifically, the size of the reference area) when a pan/tilt determination signal is not outputted. This technique is equivalent to a technique in combination of the first area setting technique and a second area setting technique that is to be described later. In this case, the object at a near distance moves to the outside of the AF evaluation area faster by causing the AF evaluation area to move in the direction of a shake vector while the size of the AF evaluation area is reduced. Accordingly, the lens position can be in-focus on the object at the long distance faster. The significance of this technique will be clearer with reference to a description of the second area setting technique to be described later.

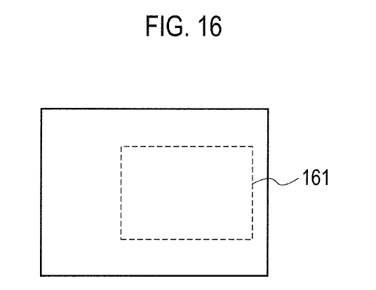

It should be noted that in the example shown in FIGS. 14A to 14I, a part of the outer circumference of the AF evaluation area to be set when a pan/tilt determination signal is outputted matches with the outer circumference of the frame image. This match is not a requirement, however. The outer circumference of the AF evaluation area to be set in a case where a pan/tilt determination signal is outputted and where angle θ is classified as the first angle level can be separated from the outer circumference of the frame image as shown in AF evaluation area 161 in FIG. 16.

In the example shown in FIG. 13 to FIGS. 14A to 14I, when a pan/tilt determination signal is outputted, the AF evaluation area is arranged at eight types of position in accordance with the directions of a shake vector. The number of types of position of the AF evaluation area in accordance with the directions of a shake vector may be not greater than seven or not less than nine, however.

Next, the second area setting technique will be described. As in the case of the description provided for the first area setting technique, consider a case where an image of a landscape as shown in FIG. 10 is shot by image shooting apparatus 1 while image shooting apparatus 1 is panned in the upper right oblique direction. Specifically, consider a case where the state of shooting the image shifts from the state of shooting flowers, as the main object, at a near distance to the state of shooting a mountain, as the main object, at a long distance, through the pan or tilt operation (or a combination of the two operations). Such shift is made through timings T1 to T5.

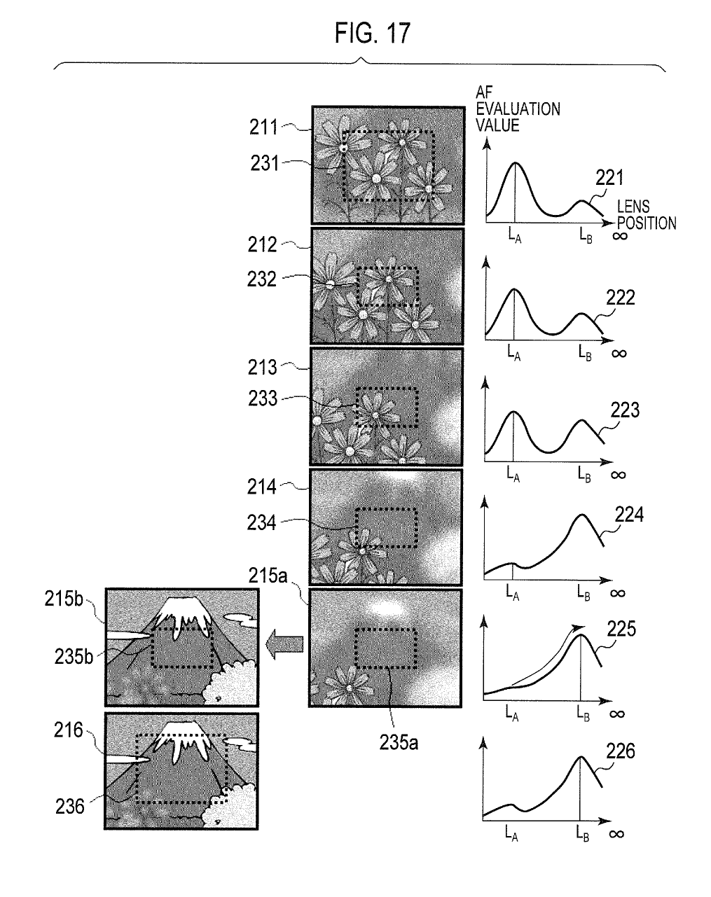

FIG. 17 is a diagram showing relationships of the respective frame images, AF evaluation areas and lens positions and AF evaluation values.

In FIG. 17, images 211, 212, 213, 214 and 215a each in a rectangular frame denoted by a solid line are frame images each obtained at timings T1, T2, T3, T4 and T5. Image 216 in a rectangular frame denoted by a solid line in FIG. 17 represents a frame image obtained at timing T6 that comes after timing T5. Image 215b in a rectangular frame denoted by a solid line in FIG. 17 represents a frame image obtained after timing T5 but before timing T6.

AF evaluation areas 231, 232, 233, 234, 235a, 235b and 236 each can be also called a contrast detection area are set to each of frame images 211, 212, 213, 214, 215a, 215b and 216, respectively by area setting unit 44.

Graphs each indicating a relationship of a lens position and an AF evaluation value are shown in the right side of FIG. 17. Curved lines 221, 222, 223, 224, 225 and 226 each representing a relationship between a lens position and an AF evaluation value correspond to frame images 211, 212, 213, 214, 215a (or 215b) and 216, respectively.

In each of the graphs representing respective curved lines 221 to 226, a horizontal axis represents a lens position and a right side of the horizontal axis corresponds to the lens position in-focus on an object at a long distance. As described in the first area setting technique, L_{A} represents a lens position in-focus on the flowers at a near distance included in the image shooting area. L_{B} represents a lens position in-focus on the mountain at a long distance included in the image shooting area.

At timing T1 corresponding to frame image 211, image shooting apparatus 1 is fixed, and the flowers at the near distance are the main object. Since image shooting apparatus 1 is fixed, a pan/tilt determination signal is not outputted at timing T1. In this case, area setting unit 44 sets the AF evaluation area to be the aforementioned reference area. AF evaluation area 231 in FIG. 17 is the reference area.

At timing T1, since the main object that fits in the image shooting area is the flowers at the near distance, in a state where the lens position matches with L_{A}, the AF evaluation value takes a local maximum value and the local maximum value (the near distance side local maximum value) matches with the maximum value of the function represented by curved line 221. For this reason, an image is shot in a state where the lens position is set to L_{A}. As a result, an image in-focus on the flowers at the near distance can be obtained. As described above, however, the AF evaluation value takes another local maximum value (the local maximum value of the long distance side) in a state where the lens position matches with L_{B}.

Image shooting apparatus 1 is panned in the upper right oblique direction during the period from timings T1 to T2. Thereby, determination unit 43 determines by the aforementioned determination process that an intentional movement is applied to image shooting apparatus 1, and then outputs a pan/tilt determination signal to area setting unit 44. In a case where the second area setting technique is employed, differently from the first area setting technique, a shake vector does not need to be provided to area setting unit 44 since a shake vector is not referred for setting the AF evaluation area.

When a pan/tilt determination signal is outputted, area setting unit 44 changes the size of the AF evaluation area smaller than that of the reference area. As a result of this, AF evaluation area 232 that is different from the reference area is set in frame image 212 in FIG. 17. The camera operation in which image shooting apparatus 1 is panned in the upper right oblique direction is continued until timing T5. As a result, each of the sizes of AF evaluation areas 233, 234, 235a and 235b of the frame images also becomes smaller than that of the reference area. Because of such reduction in size, the object at the near distance is removed from the AF evaluation area at an early period. The centers of AF evaluation areas 232, 233, 234, 235a and 235b match with the centers of the respective frame images, for example, as in the case of AF evaluation area 231.

As the time progresses from timings T1 to T5, the magnitude relationship between the area sizes in the frame image occupied by the objects at the near distance and at the long distance is reversed. Then, in frame image 214, the long distance side local maximum value becomes greater than the near distance side local maximum value. At timing T4 corresponding to frame image 214, the near distance side local maximum value still exists and the lens position is set to L_{A}. Thereafter, when the time progresses to timing T5, the near distance side local maximum value disappears, and the lens position is controlled and moved towards L_{B} by the hill-climbing control. The reduction in size of the AF evaluation area contributes to such disappearance (disappearance at an early period) of the near distance side local maximum value.

Frame image 215a is the frame image that can be obtained immediately after the near distance side local maximum value disappears. At the timing of shooting this frame image, the lens position still matches with L_{A}. Thereafter, as the lens position moves towards L_{B}, frame image 215b in-focus on an object at the long distance can be obtained.

Then, at timing T6, assume that image shooting apparatus 1 is fixed. In this case, since a pan/tilt determination signal is not outputted at timing T6, area setting unit 44 returns the AF evaluation area to the reference area. Specifically, AF evaluation area 236 corresponding to timing T6 is the reference area. As a result of this, the two local maximum values (specifically, a near distance side local maximum value and long distance side local maximum value) appear in the function expressed by curved line 226. However, since the hill-climbing control is executed around the long distance side local maximum value corresponding to L_{B}, the state of the lens position in-focus on an object at the long distance is maintained.

As described above, in the second area setting technique, the size of the AF evaluation area is reduced in order to remove the object at the near distance at an early period (the size thereof is reduced so that the outer shape of the AF evaluation area is directed towards the center of the frame image) when an intentional movement is applied to image shooting apparatus 1. Thereby, as it can be understood from a comparison between FIG. 17 and FIG. 20 that is related to a conventional technique, at an early timing, the lens position can be in-focus on the object at the long distance, which is the image the photographer intends to shoot. Thereby, the camera operation to frame out an object at a near distance is no longer necessary.

In addition, although the size of the AF evaluation area can be reduced to the target size at once when the state where a pan/tilt determination signal is not outputted shifts to the state where a pan/tilt determination signal is outputted. It is, however, preferable that the size of the AF evaluation area be gradually reduced from the reference size to the target size through a plurality of stages. Here, the reference size is the size of the reference area corresponding to AF evaluation area 231 in FIG. 17. The target size is the size of AF evaluation area 232 in FIG. 17.

Consider a case where a pan/tilt determination signal is not outputted with respect to the (n−1)th frame image and where a pan/tilt determination signal is outputted with respect to each image frame after the nth frame, for example. In this case, the size of the AF evaluation area is reduced from the reference size to the target size, and this reduction process is gradually executed using a plurality of frames. Specifically, in a case where the sizes of the AF evaluation areas of the (n−1)th, nth, (n+1)th and (n+2)th frame images are expressed as SIZEₙ₋₁, SIZEₙ, SIZEₙ₊₁ and SIZEₙ₊₂, respectively, and the reduction process is gradually executed using three frames, the inequality expression, “SIZEₙ₋₁>SIZEₙ>SIZEₙ₊₁>SIZEₙ₊₂” is set to be true, and also, SIZEₙ₋₁ is set to be the reference size and SIZEₙ₊₂ is set to be the target size.

Hypothetically, in a case where the size of the AF evaluation area is reduced from the reference size to the target size at once, the object that fits in the AF evaluation area changes at once, so that the continuity of the AF evaluation values is not assured, resulting in the occurrence of a situation where it is not clear whether focus lens 31 should be moved to either the long distance side or near distance side in the hill-climbing control (specifically, there is a concern that the hill-climbing control may be interrupted once). On the other hand, when the AF evaluation area is gradually reduced from the reference size to the target size though a plurality of stages, as described above, the continuity of the AF evaluation values is assured, thus avoiding an interruption of the hill-climbing control.

[Operation Flowchart]

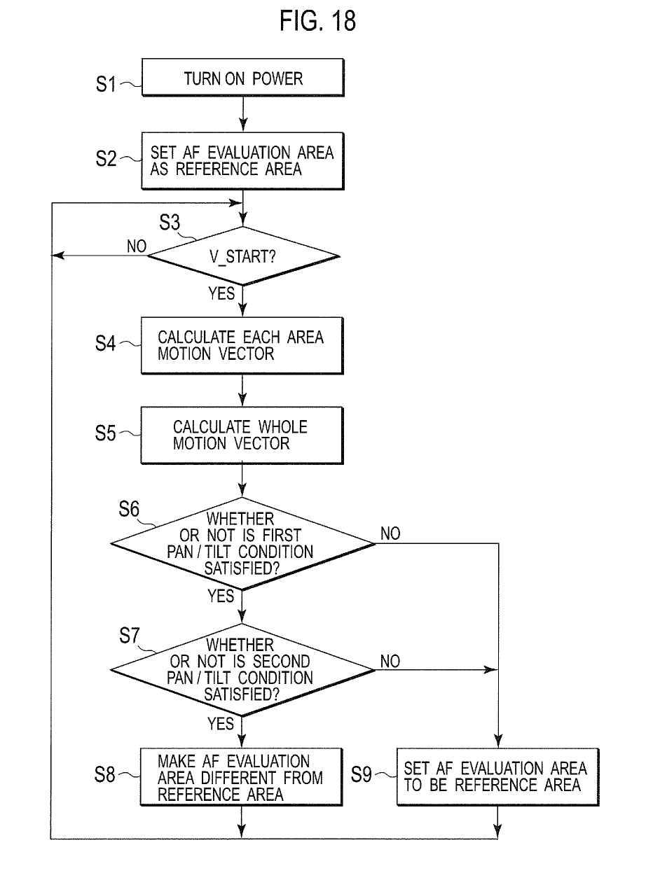

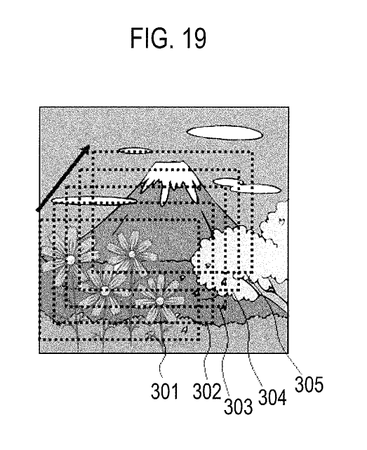

Next, the flow of an operation of image shooting apparatus 1, related to the setting of an AF evaluation area will be described. FIG. 18 is a flowchart showing the flow of the operation.

When a power is supplied to image shooting apparatus 1 (step S1), first, an AF evaluation area is set to be the reference area (step S2). Thereafter, whether or not a vertical synchronizing signal is outputted from TG 22 is confirmed in step S3. The vertical synchronizing signal is generated and outputted at the starting point of each frame, and an output signal of image pickup element 33 is read in synchronization with the vertical synchronizing signal, and thus, frame images are sequentially obtained. In a case where a vertical synchronizing signal is outputted from TG 22, the operation proceeds to step S4. In a case where a vertical synchronizing signal is not outputted from TG 22, the process in step S3 is repeated.

In step S4, area motion vectors are calculated between the latest frame image and the frame image immediately before the latest frame image, and a whole motion vector is calculated from the area motion vectors.

Thereafter, determinations are made whether or not the first and second pan/tilt conditions are satisfied. In a case where both of the first and second pan/tilt conditions are satisfied, the operation proceeds to step S8, and the AF evaluation area is made different from the reference area. Specifically, as described above, the AF evaluation area is moved in the direction of the shake vector, or the size of the AF evaluation area is reduced. On the other hand, in a case where neither the first or second conditions is satisfied, or any one of the first and second conditions is unsatisfied, the operation proceeds to step S9, and the AF evaluation area is set to be the reference area. When the AF evaluation area is set in step S8 or S9, the operation returns to step S3, and the process of each of the aforementioned steps is repeated.

<Modifications>

A modification example or notations of the aforementioned embodiment will be described. Contents described in the respective notations can be optionally combined unless there is a discrepancy between them.

Specific numerical values shown in the aforementioned descriptions are mere exemplifications. Accordingly, as a matter of course, these numerical values can be changed to various numerical values. Furthermore, although a case where an object to be in-focus on is shifted from a near distance to a long distance is exemplified, the same can be applied to a case reversal to the aforementioned case.

In the aforementioned embodiment, a motion vector is calculated from an image signal, and a determination is made on the basis of the motion vector whether or not an intentional movement is applied to image shooting apparatus 1. It is also possible to implement a hand shake detection sensor (not shown) in image shooting apparatus 1 and then to make a determination on the basis of an output signal from the hand shake detection sensor whether or not an intentional movement is applied to image shooting apparatus 1. The hand shake detection sensor may be an angle speed sensor (not shown), which detects an angle speed of image shooting apparatus 1, or an acceleration sensor (not shown), which detects an acceleration of image shooting apparatus 1, for example. A determination that an intentional movement is applied to image shooting apparatus 1 is made when image shooting apparatus 1 is determined, by use of an angle speed sensor, to be continuously rotated, for a predetermined number of frames, in a right direction around a vertical line as the rotation axis, for example.

Furthermore, image shooting apparatus 1 in FIG. 1 can be implemented as a hardware device or a combination of hardware and software. Specifically, the functions of each of the components shown in FIG. 3 can be implemented as a hardware or software component or a combination of hardware and software.

In a case where image shooting apparatus 1 is configured using software, a block diagram as to the component implemented by software represents the function block diagram of the component. In addition, a function of each of the components may partially or entirely be written as a program. In this case, the program may be executed on a program execution device (a computer, for example), and thereby, the entire or part of the function may be implemented.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An image shooting apparatus comprising:
an imaging unit configured to photoelectrically obtain a shot image;
a motion detector configured to detect movement of an object in the shot image and to generate a motion vector;
an area setting unit configured to receive the motion vector, and to set a focus evaluation area in the shot image, wherein the area setting unit changes a focus evaluation area position based on the motion vector;
an evaluation unit configured to receive the shot image and to calculate a focus evaluation value corresponding to the amount of contrast in the focus evaluation area set by the area setting unit; and
a controller configured to receive the focus evaluation value and to control the imaging unit so that the focus evaluation value can take an extreme value.

2. The image shooting apparatus as claimed in claim 1, wherein the area setting unit receives the motion vector and changes the focus evaluation area position based on the motion vector, in a direction substantially the same as the direction of the movement of the image shooting apparatus.

3. The image shooting apparatus as claimed in claim 1, further comprising
a determination unit configured to receive a motion vector detected by the motion detector and then to determine, based on the motion vector, whether or not an intentional camera operation is applied to the image shooting apparatus by a user.

4. The image shooting apparatus as claimed in claim 3, wherein when the determination unit determinates that an intentional camera operation is applied to the image shooting apparatus, the area setting unit changes the position of the focus evaluation area through a plurality of stages, from a predetermined position towards a target position in accordance with the direction of movement of the image shooting apparatus.

5. The image shooting apparatus as claimed in claim 1, wherein when the determination unit determines that an intentional camera operation is applied to the image shooting apparatus, the area setting unit changes the position of the focus evaluation area from a predetermined position in a direction corresponding to the direction of movement of the image shooting apparatus, and reduces the size of the focus evaluation area.

6. An image shooting apparatus comprising:
an imaging unit configured to photoelectrically obtain a shot image;
a motion detector configured to detect movement of an object in the shot image and then to generate a motion vector;
an area setting unit configured to receive the motion vector, and to set a focus evaluation area in the shot image, wherein the area setting unit reduces the size of a focus evaluation area based on the motion vector;
an evaluation unit configured to receive the shot image and to calculate a focus evaluation value corresponding to the amount of contrast in the focus evaluation area set by the area setting unit; and
a controller configured to receive the focus evaluation value and to control the imaging unit so that the focus evaluation value can take an extreme value.

7. The image shooting apparatus as claimed in claim 6, further comprising:
a determination unit configured to receive a motion vector detected by the motion detector and to determine based on the motion vector, whether an intentional camera operation is applied to the image shooting apparatus by a user.

8. The image shooting apparatus as claimed in claim 6, wherein the area setting unit reduces the size of the focus evaluation area through a plurality of stages when a determination is made that an intentional camera operation is applied to the image shooting apparatus.

9. A focus control method comprising:
detecting movement of an object in a shot image photoelectrically obtained by an imaging unit and then generating a motion vector;
setting a focus evaluation area in the shot image by changing a focus evaluation area position in the shot image based on the motion vector;
calculating a focus evaluation value corresponding to the amount of contrast in the focus evaluation area; and
controlling the imaging unit so that the focus evaluation value can take an extreme value.

10. The method as claimed in claim 9, wherein setting a focus evaluation area includes changing the focus evaluation area position based on the motion vector, in a direction substantially the same as the direction of movement of the image shooting apparatus.

11. The method as claimed in claim 9, further comprising
determining, based on the motion vector, whether or not an intentional camera operation is applied to the image shooting apparatus by a user.

12. The method as claimed in claim 11, wherein when an intentional camera operation is found applied to the image shooting apparatus, the setting the focus evaluation area includes changing the position of the focus evaluation area through a plurality of stages from a predetermined position towards a target position in accordance with the direction of movement of the image shooting apparatus.

13. The method as claimed in claim 1, wherein when an intentional camera operation is found applied to the image shooting apparatus, the setting the focus evaluation area includes changing the position of the focus evaluation area from a predetermined position in a direction corresponding to the direction of movement of the image shooting apparatus, and reduces the size of the focus evaluation area.

14. A focus control method comprising:
detecting movement of an object in a shot image photoelectrically obtained by an imaging unit and then generating a motion vector;
setting a focus evaluation area in the shot image by reducing the size of a focus evaluation area based on the motion vector;
calculating a focus evaluation value corresponding to the amount of contrast in the focus evaluation area set by the area setting unit; and
controlling the imaging unit so that the focus evaluation value can take an extreme value.

15. The method as claimed in claim 14, further comprising:
determining, based on the motion vector, whether an intentional camera operation is applied to the image shooting apparatus by a user.

16. The method as claimed in claim 14, wherein when an intentional camera operation is found applied to the image shooting apparatus, the size of the focus evaluation area is reduced through a plurality of stages.
